(19) United States
(12) Patent Application Publication
(10) Pub. No.: US 2002/0145634 A1
(43) Pub. Date: Oct. 10, 2002

(54) Multimedia computerized patient record system

(76) Inventors: Manoucher Gueramy, Midland, MI (US); Anthony D. Gueramy, Midland, MI (US); Paul D. Ries, Midland, MI (US); Michael E. Hunt, Midland, MI (US)

Correspondence Address: HARNESS, DICKEY & PIERCE, P.L.C., P.O. BOX 828, BLOOMFIELD HILLS, MI, 48303, US

(21) Appl. No.: 10/002,486

(22) Filed: Nov. 1, 2001

Related U.S. Application Data
(60) Provisional application No. 60/245,750, filed on Nov. 3, 2000.

(51) Int. Cl. G09G 5/00

(52) U.S. Cl. 345/840

(57) ABSTRACT

A multimedia computerized patient medical record system is provided that employs an interactive graphic user interface. The patient medical record system organizes data entry, retrieval and presentation to enhance the ability of specialized medical professionals in more efficiently and successfully completing medical decisions, and thus deliver improved patient healthcare. An interactive graphical user interface is provided which is customized based on specialization of particular physician practices. Furthermore, customization yields an attractive easy-to-use system because the interactive graphical user interface is implemented with specific considerations directed to a physician high speed work flow and great dependency on accurate information. Thus, an interactive graphical user interface with an ergonomic implementation is produced in which the display is integrated with an interactive aspect to allow user input and manipulation of the data.

This application claims the benefit of U.S. Provisional Application No. 60/245,750, filed Nov. 3, 2000 and entitled “Multimedia Computerized Patient Record System” the specification and drawings of which are hereby expressly incorporated by reference.

### BACKGROUND OF THE INVENTION

The present invention relates generally to patient medical record systems. More particularly, the invention relates to a multimedia apparatus employing an interactive graphic user interface that sends and receives patient information via a network.

Medical professionals, particularly physicians, are involved in a practice of medicine that is highly sophisticated. Technological development makes available voluminous information that a physician is often required to consider quickly in making a medical diagnosis. Furthermore, changes in health care management pressure physicians to make rapid decisions based not only on patient medical information, but also on implications resulting from managed care, such as the limitations imposed on a physician's decisions from insurance companies. Physicians, therefore, often need to review comprehensive collected data, render a diagnosis and determine future action under the limitations of resources, time, and managed care.

Patient medical record systems in use today involve an often complex collection of information from various data sources. For example, these data sources can range from simple text to multimedia medical data, MRI data, x-ray data and even 3-D imaging data that may facilitate the determination of a medical diagnosis with improved precision, accuracy and less time. However, a too voluminous availability and presentation of medical data may also impede a physician's ability to best perform a medical diagnosis.

Not every physician wants to view all available medical information. Medical professionals are specialized such that preferences of particular types of medical data and information develop. For example, a neurosurgeon's predilection may be to obtain imaging of the brain and head trauma information, whereas a plastic surgeon may desire blood work and x-rays. Accordingly, medical information delivered in a specialized manner would assist physicians. More relevant information would be quickly provided and less relevant information would be minimally provided to effectively aid the physician in making a diagnosis.

Current systems are deficient because insufficient and irrelevant medical information is provided to a greater degree than much desired and relevant medical information. Additionally, data acquisition is not effectively executed because either excessive or insufficient amounts are obtained. Further problems with current systems include incomplete data retrieval, and if data is retrieved, then inflexible translation of various data formats. Interfaces provided in current systems are often difficult to use and information is inadequately displayed. Current systems give little consideration to principals of ergonomic design, and also are delinquent in organizing data retrieval in a user-friendly manner. Navigation through current systems is cumbersome, difficult for the medical professional to master, and expends excessive time. Consequently, current systems are limited in becoming a successful medical related diagnostic tool.

The present invention addresses the forgoing issues by providing a patient medical record system that provides an interactive medical diagnostic tool. The patient medical record system of the present invention organizes data entry, retrieval and presentation to enhance the ability of specialized medical professionals in more efficiently and successfully completing medical decisions, and thus deliver improved patient healthcare. An interactive graphical user interface is provided which is customized based on specialization of particular physician practices. Furthermore, customizations yield an attractive easy-to-use system because the interactive graphical user interface is implemented with specific considerations directed to a physician high speed work flow and great dependency on accurate information. Thus, an interactive graphical user interface with an ergonomic implementation is produced in which the display is integrated with an interactive aspect to allow user input manipulation of the data. These specific considerations are also utilized to select data availability and organization. As specialized physicians may demand quicker access and more detailed data for more relevant medical information and less immediate access and less detail for less relevant medical information based on their particular practice, data organization is developed accordingly.

The patient medical system may obtain data via a network. Therefore, data is retrieved from a variety of sources and formats. Adequate translation prepares data for viewing and use with the interactive graphical user interface. The interactive graphical user interface provides transmission of input and communicates output via a network in a wireless configuration.

In comparison with other systems, the patient medical record system of the present invention has several advantages. The graphical user interface is provided in a mobile and wireless configuration. The graphical user interface is arranged in an ergonomic user-friendly manner such that physicians may quickly and accurately manipulate through the patient medical record system. The graphical user interface and data organization is customized for particular practice areas. Moreover, the patient medical record system facilitates medical data collection, analysis and treatment implementation by the physician. The patient medical record system assists any physician's practice.

For a more complete understanding of the invention, its objects and advantages, refer to the following specification and to the accompanying drawings.

### BRIEF DESCRIPTION OF THE DRAWINGS

FIG. 1 is a system block diagram illustrating a multimedia patient medical record system of the present invention in a wireless network computer system environment;

FIG. 2 is a diagrammatic view of the patient medical record system of FIG. 1;

FIG. 3 is a depiction of an exemplary bookmark screen used in the system of FIG. 1;

FIG. 4 is a depiction of an exemplary dictation screen used with the patient medical record system of FIG. 1;

FIG. 5 is a depiction of a reference screen of the patient medical record system of FIG. 1;

FIG. 6 is a depiction of an exemplary inbox screen of the patient medical record system of FIG. 1;

FIG. 7 is a depiction of an exemplary chart view screen of the patient record system of FIG. 1;

FIG. 8 is a site map of the patient medical record system of FIG. 1;

FIG. 9 is a detailed block diagram further illustrating the patient medical record system of FIG. 1; and

FIGS. 10a-i; 11a-c; 12a-f; and 13a-f are exemplary screens generated by the medical record system.

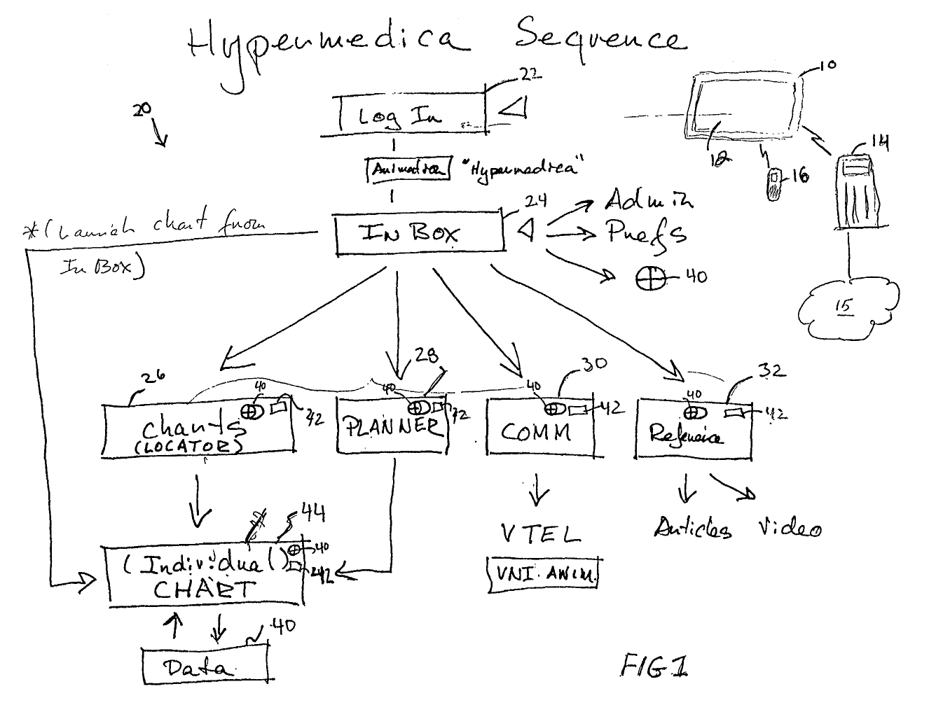

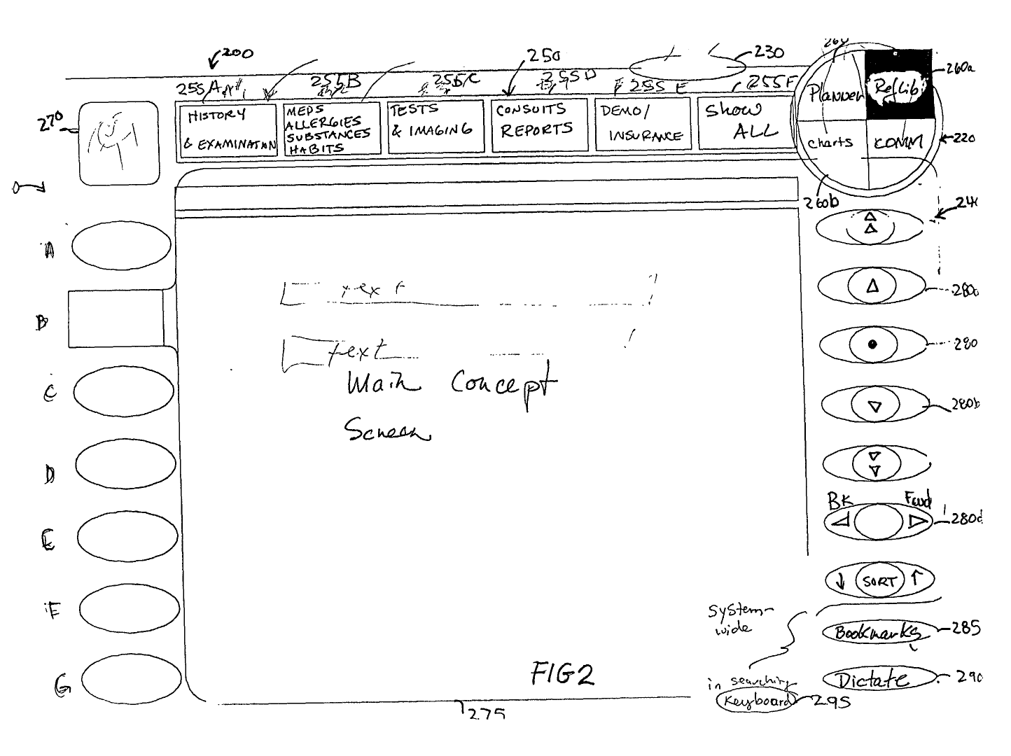

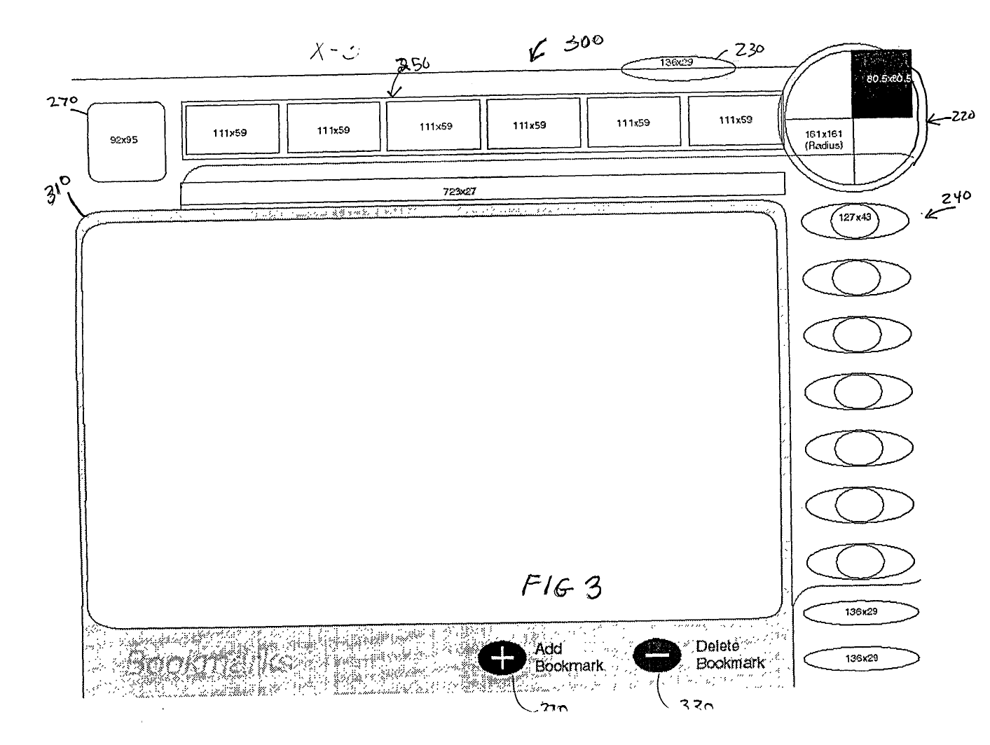

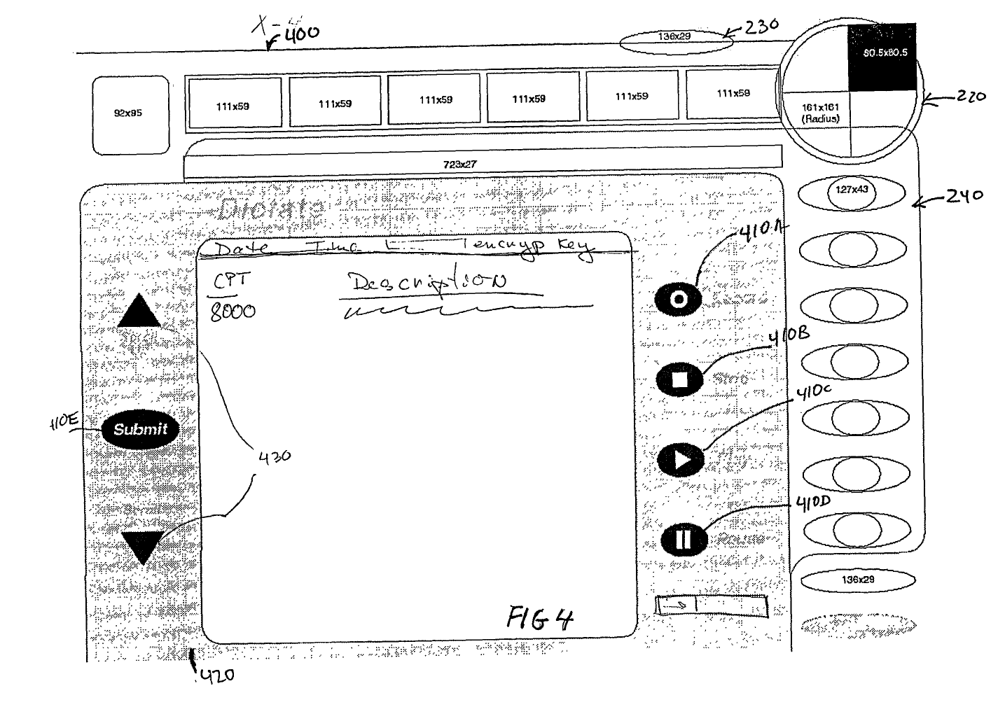

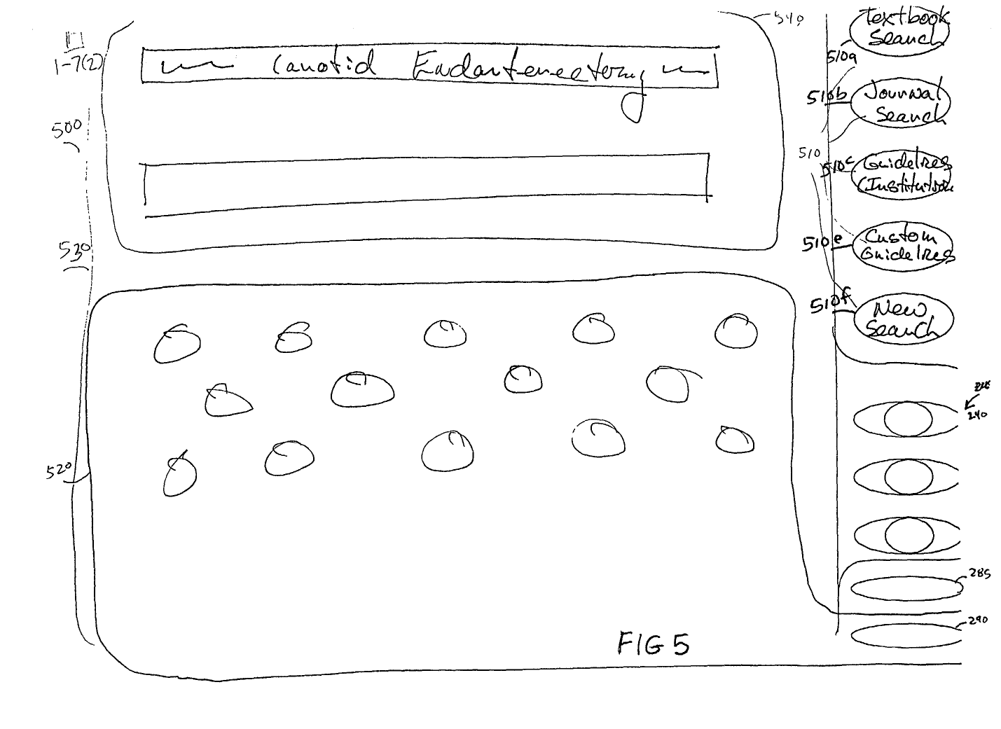

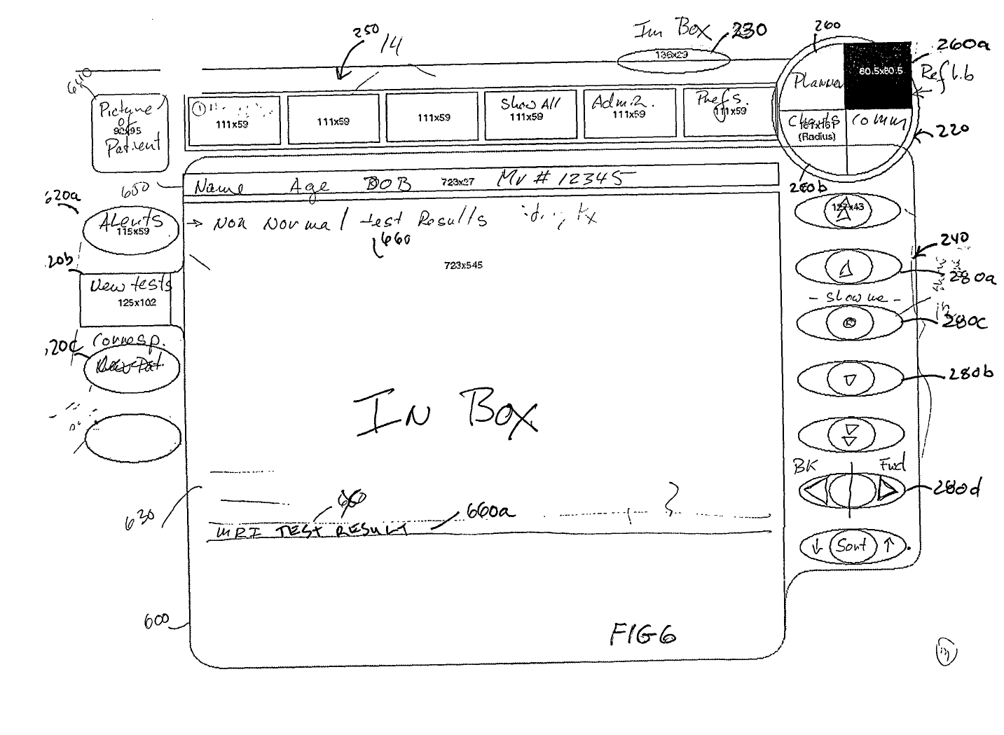

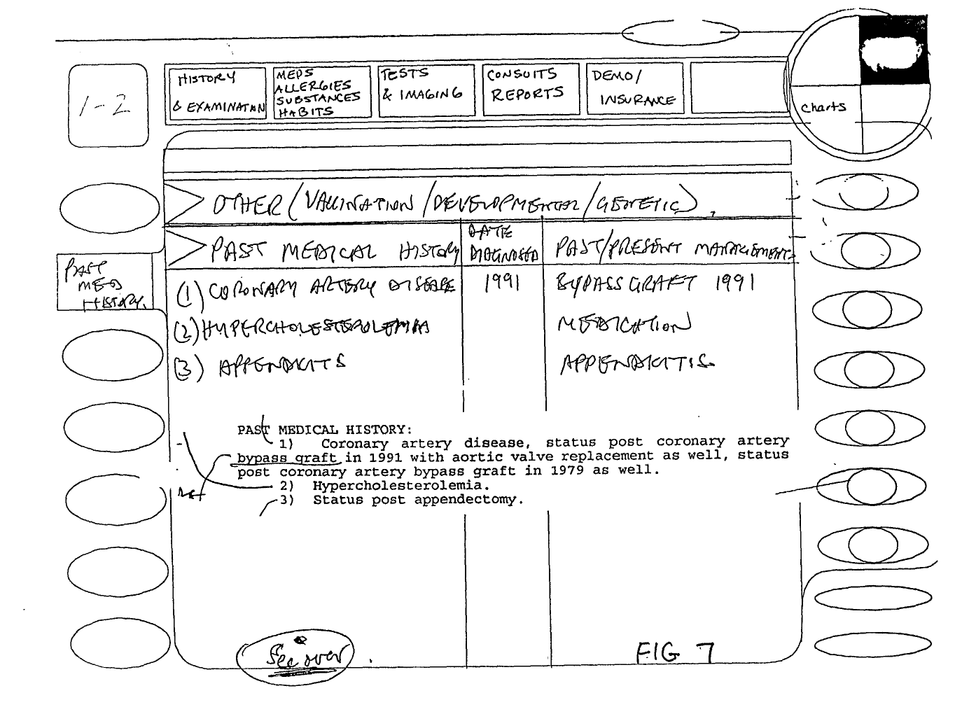

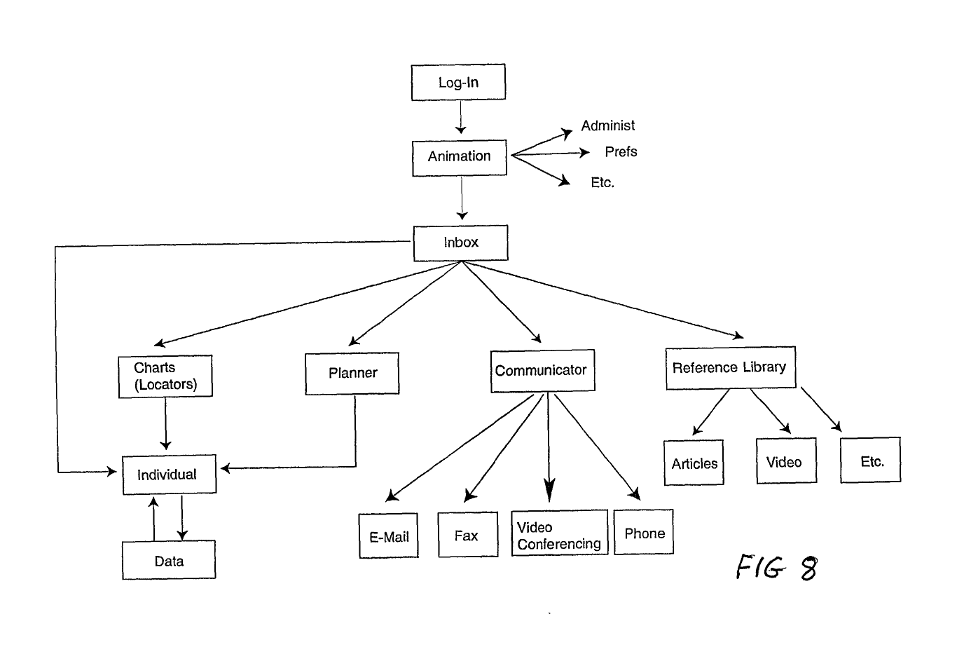

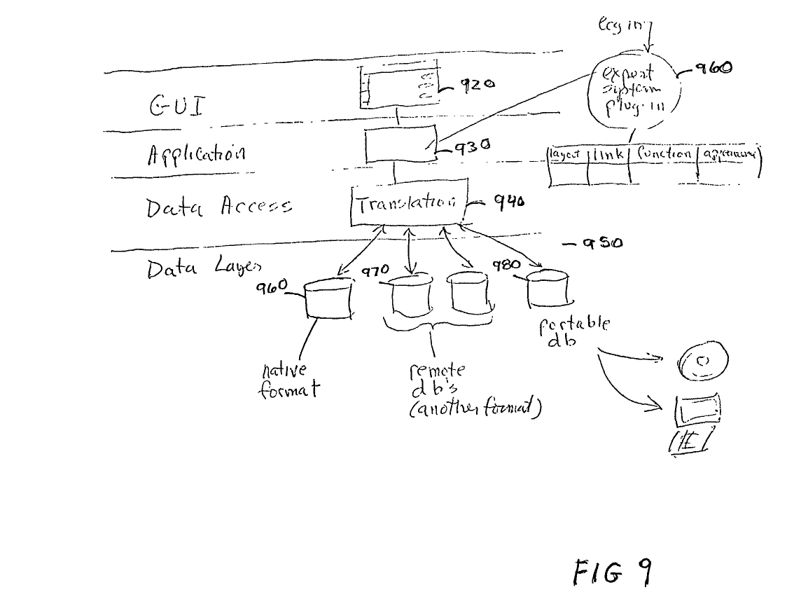

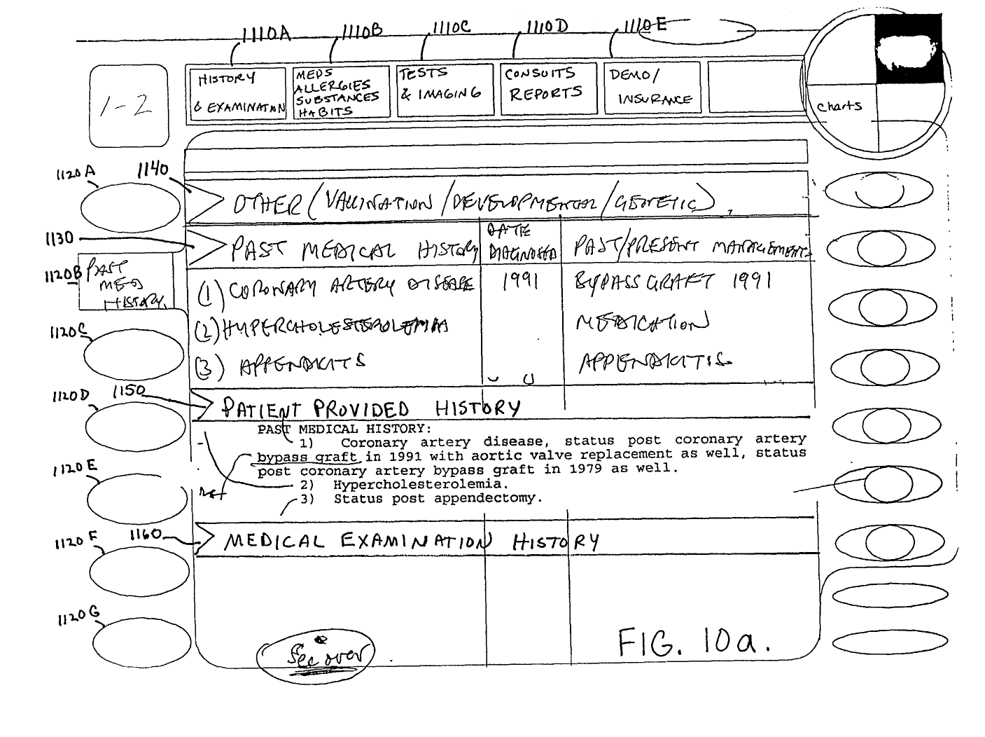

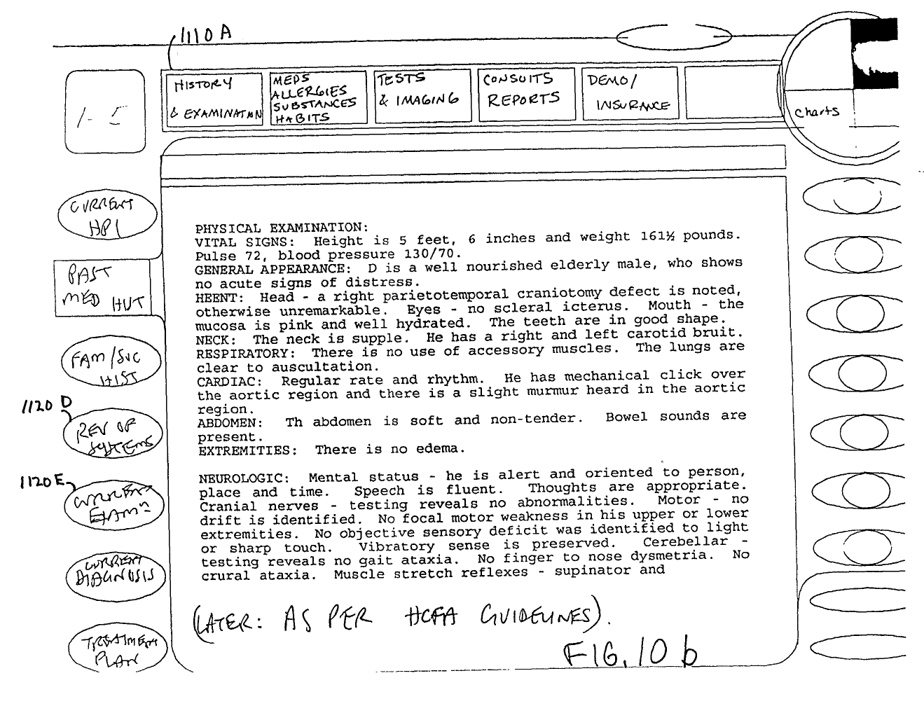

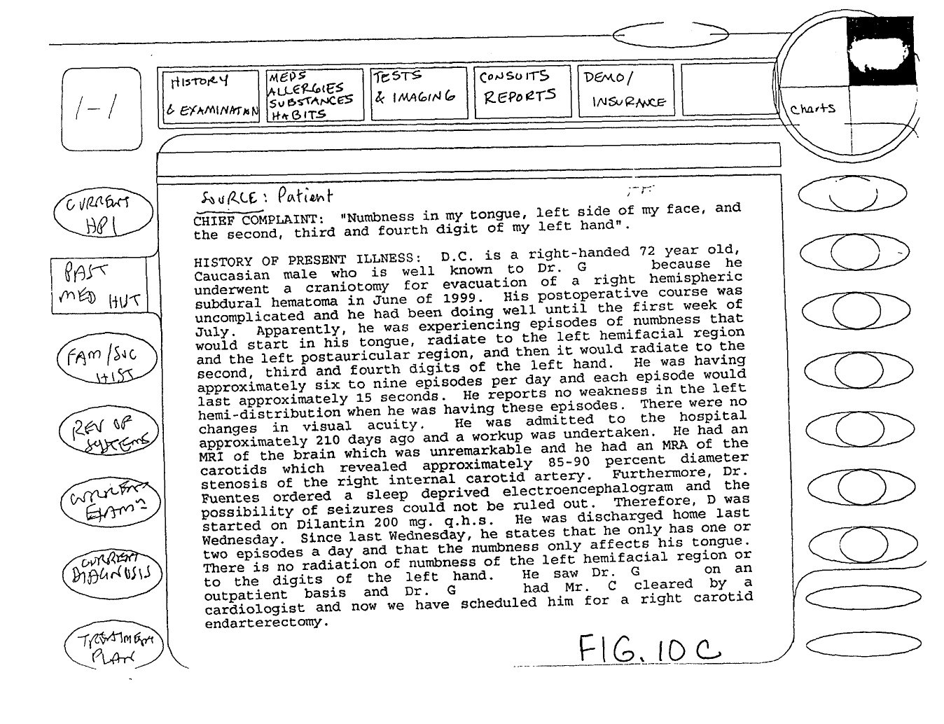

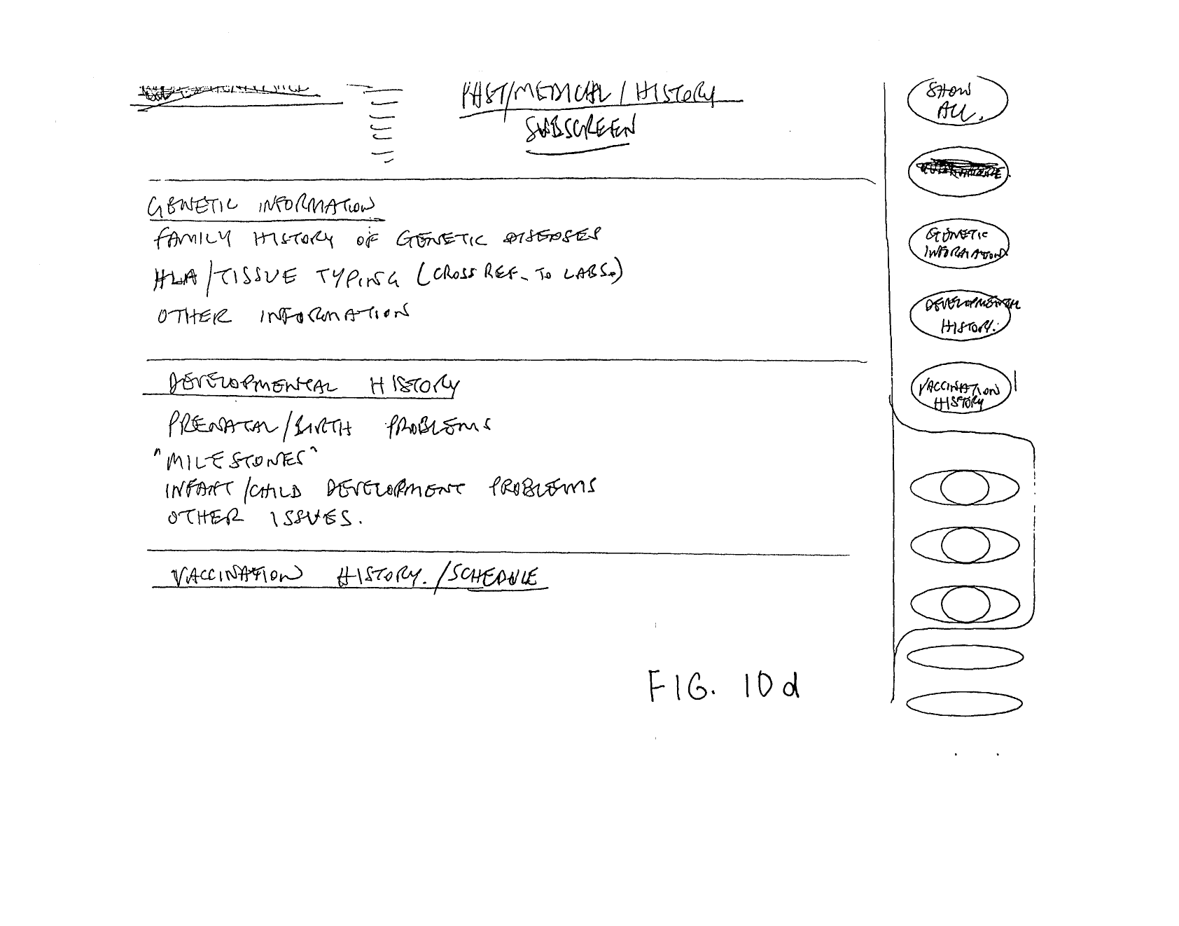

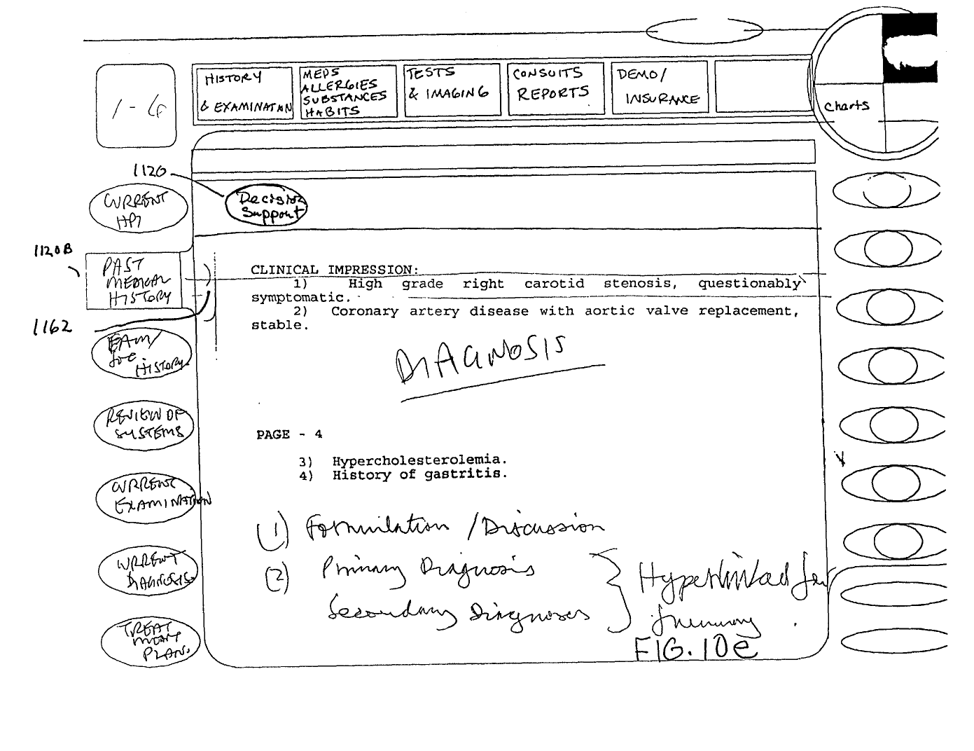

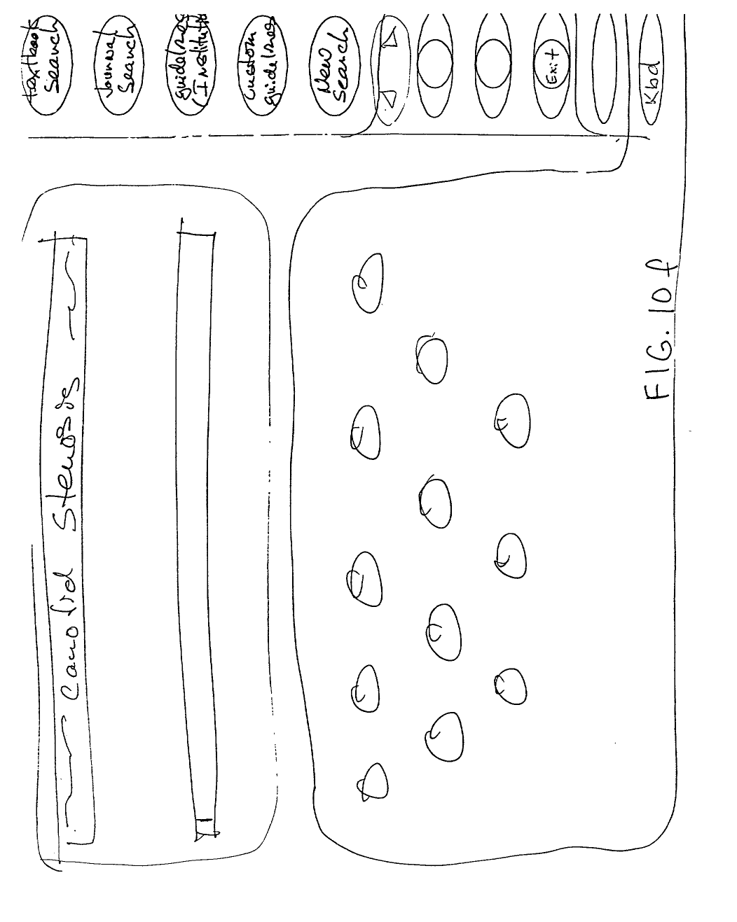

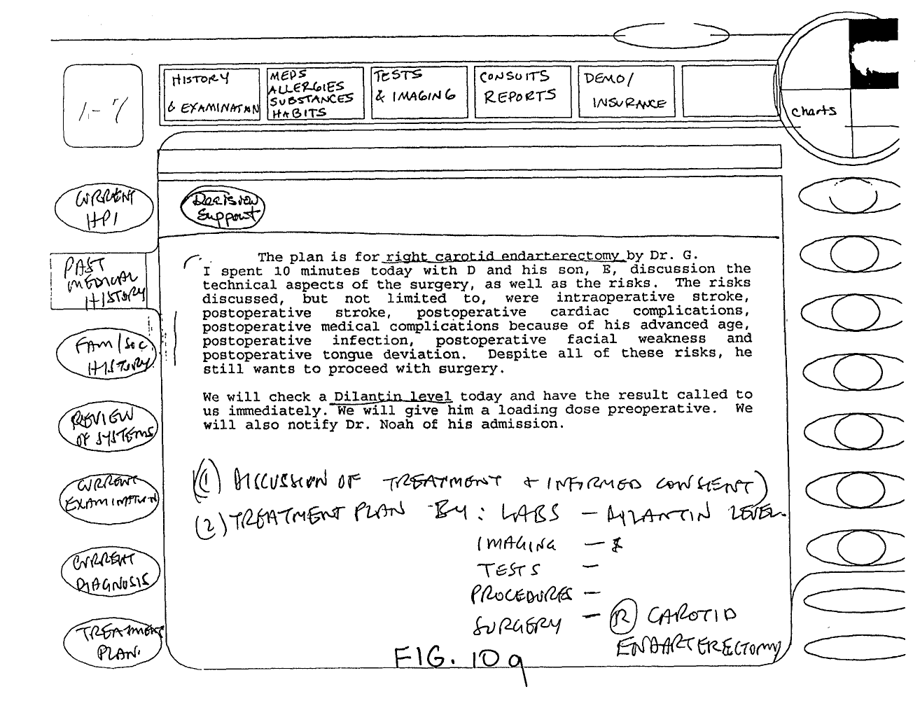

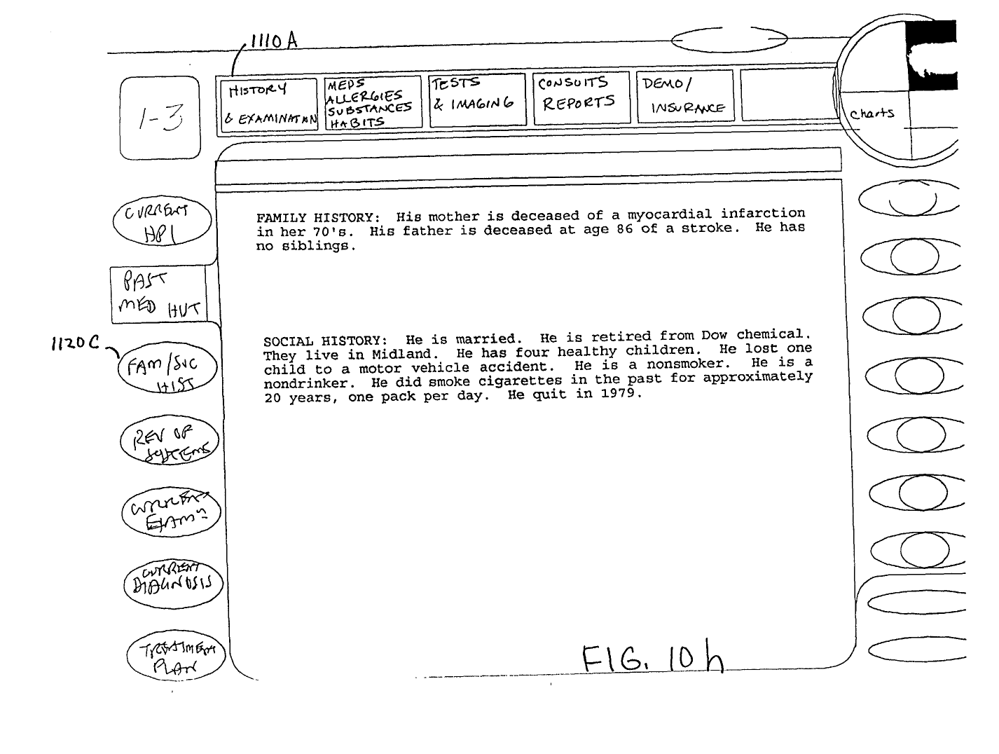

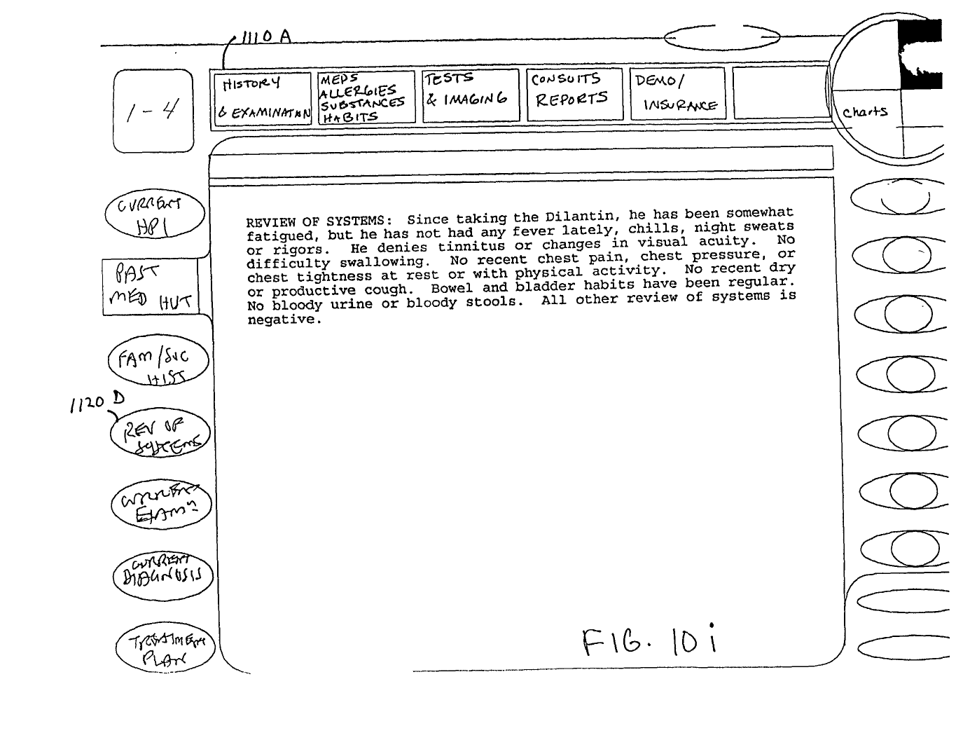

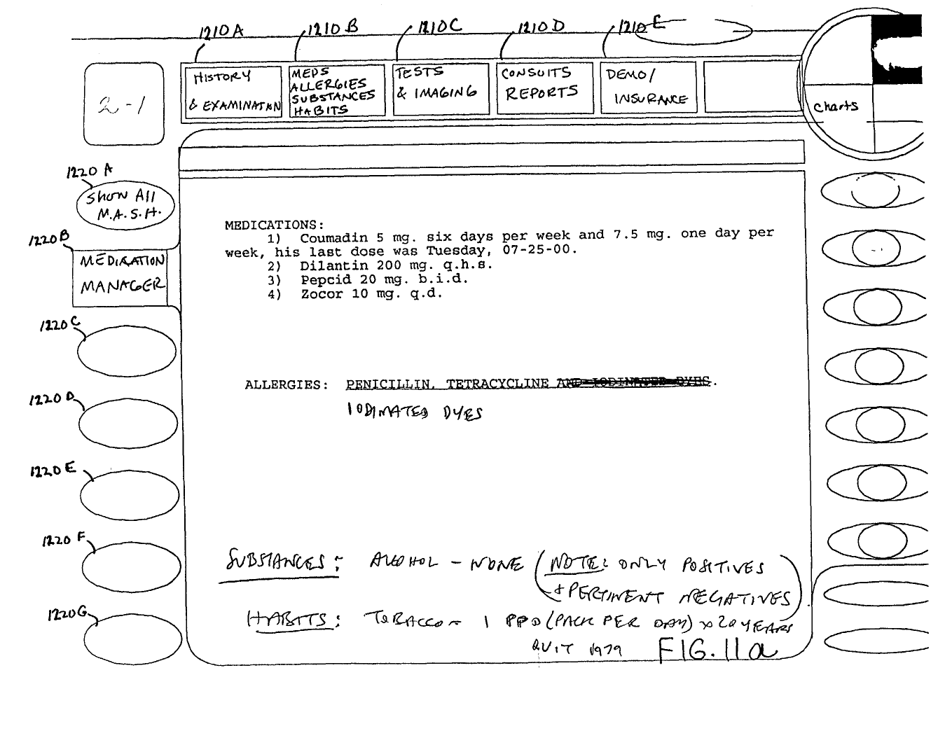

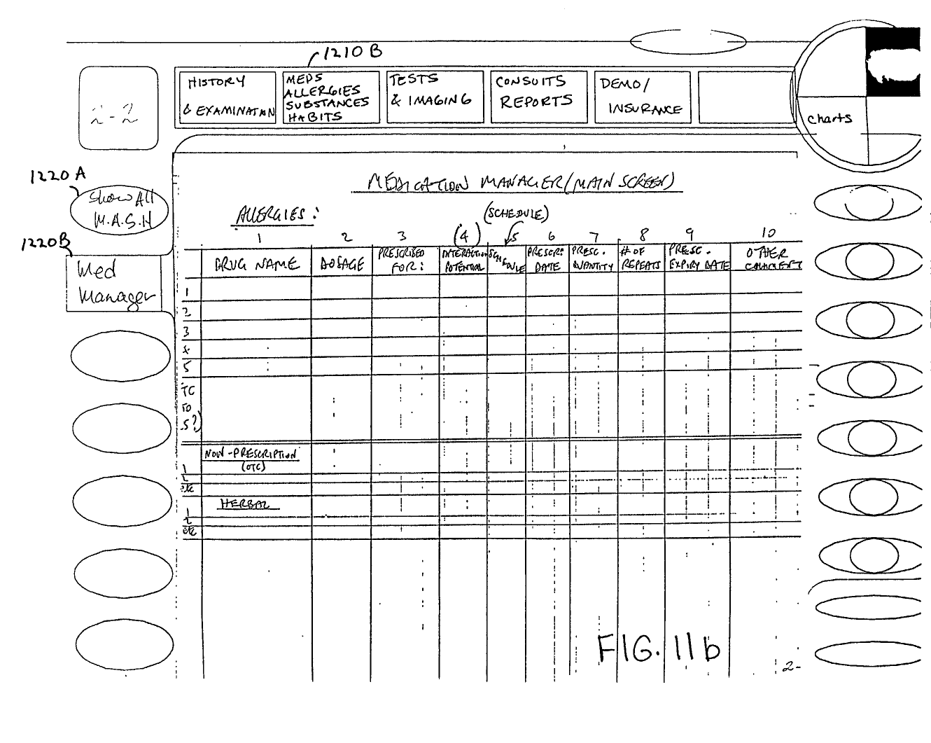

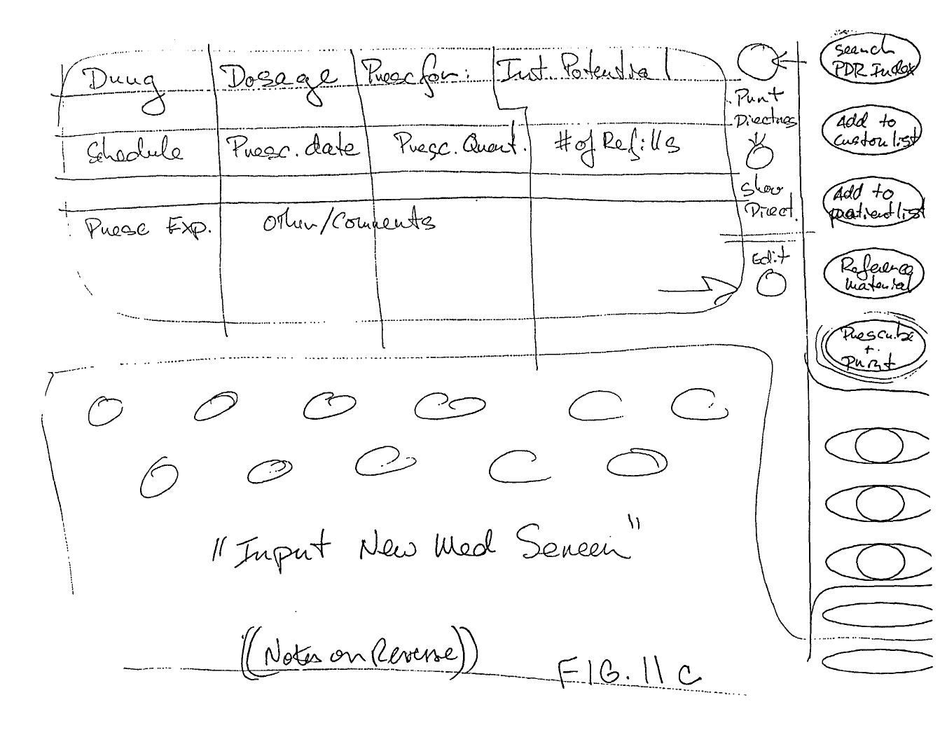

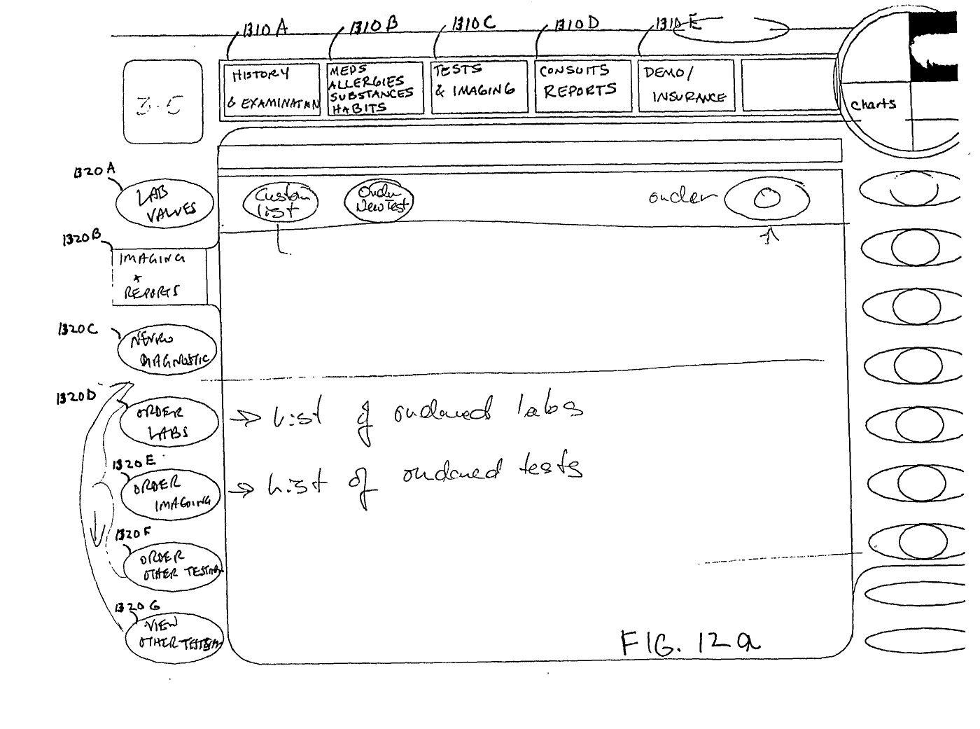

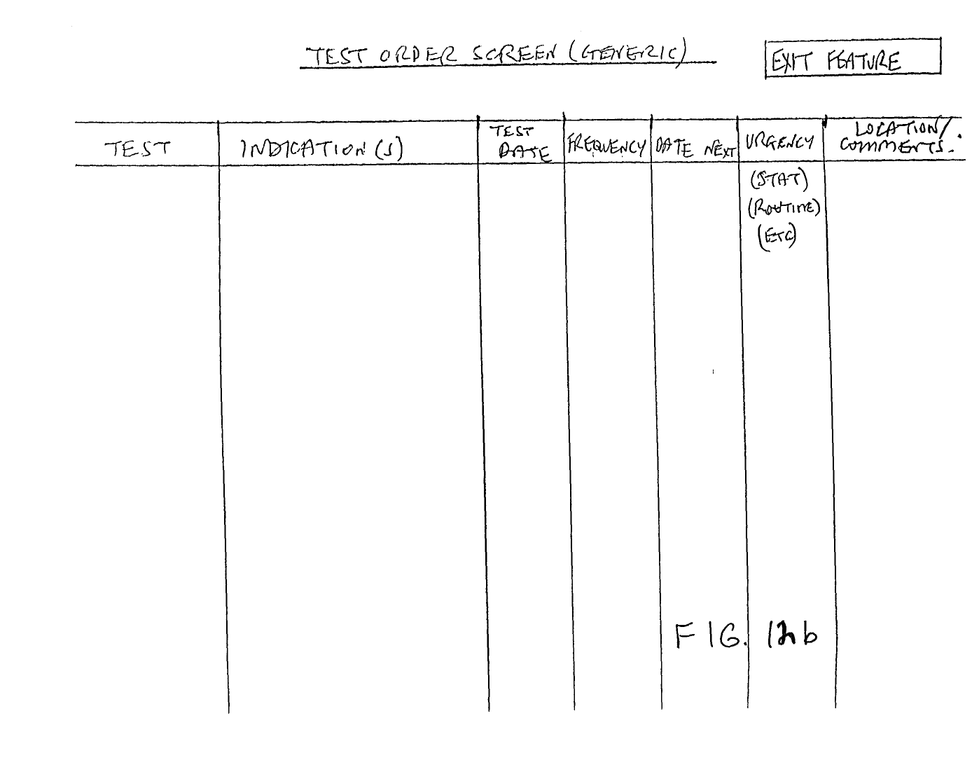

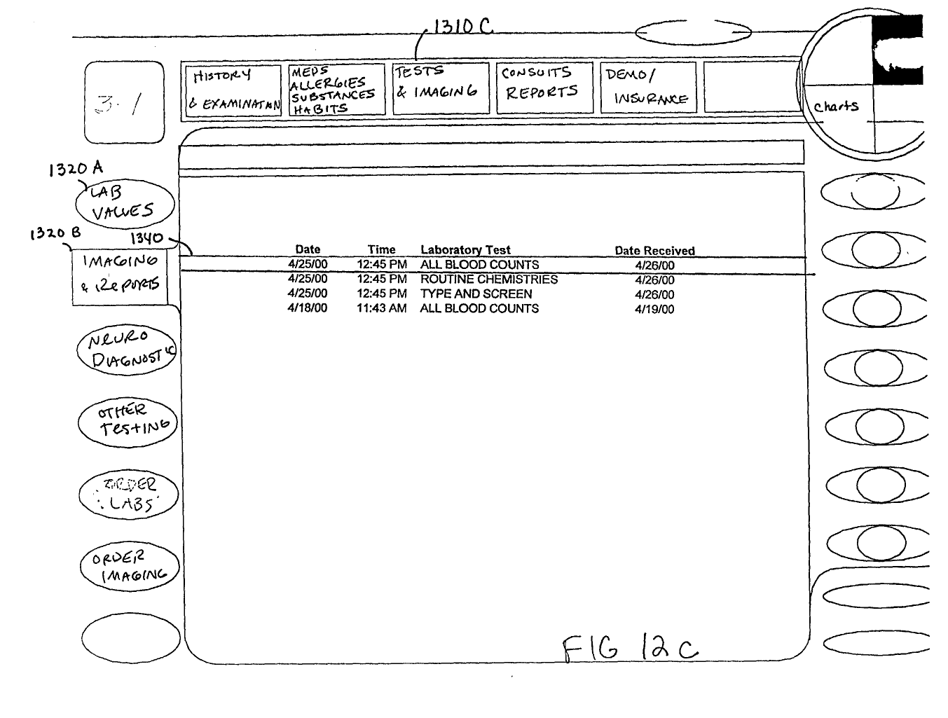

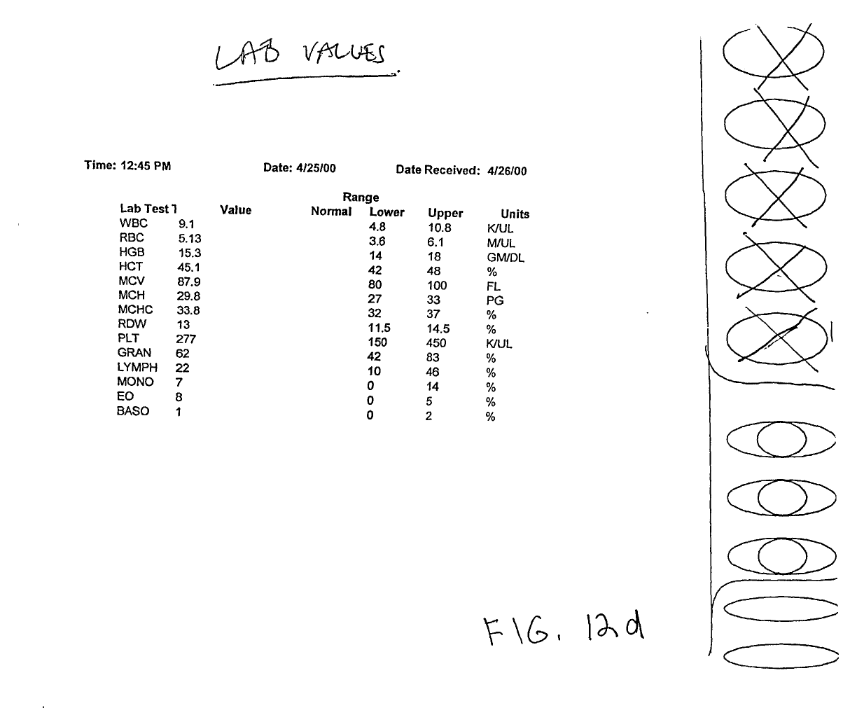

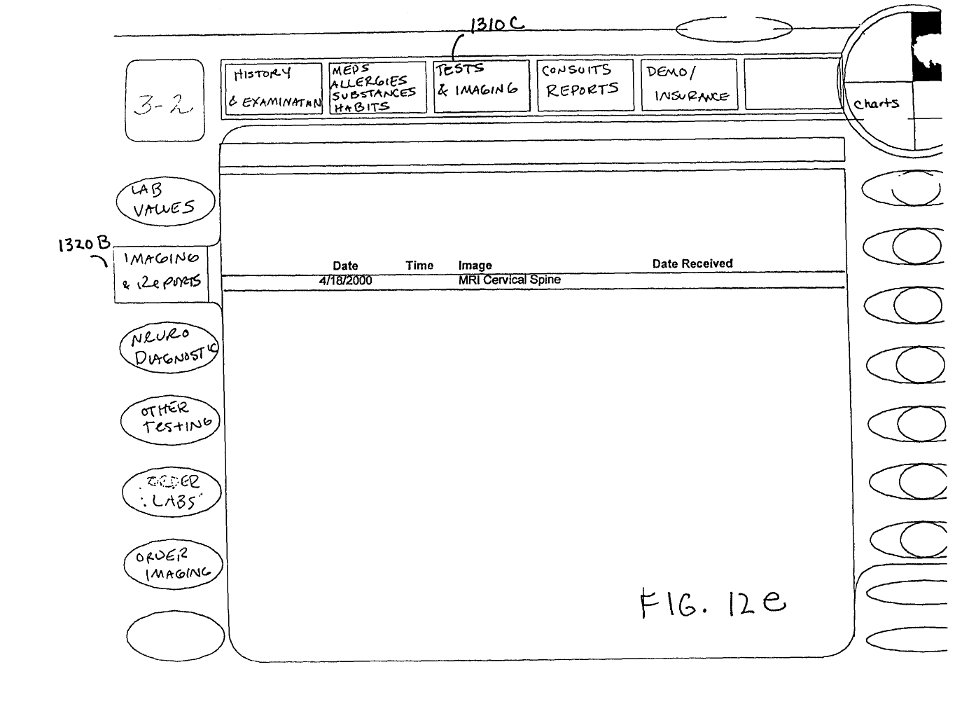

### DETAILED DESCRIPTION OF THE PREFERRED EMBODIMENTS

The present patient record system will work with a variety of communication system implementations. Local user terminal 10 includes a display 12 which communicates in a wired or wireless configuration with computer 14 and input dictation device 16. The computer 14 communicates with a network 15 to participate in data transmission and retrieval by interactive services, including but not limited to Internet services, world-wide web services, bulletin board services, e-mail services, multimedia, audio and video delivery services, local area network services, wide area network services and telephone services.

The patient record system generally shown at 20 is designed to display patient information and related medical information. The user may interact with the system to obtain real time access from any location to a patient's comprehensive medical record, including text, images, video and audio. Consequently, an interactive GUI (graphical user interface) is provided which facilitates data archiving, retrieval, viewing, point of care diagnosis and treatment recommendation. The preferred GUI is implemented using screens, such as login screens 22, inbox screens 24, chart locator screens 26, planner screens 28, communication screens 30 by preferably VTEL reference screens 32, and universal interactive templates 38, including medicine navigation template 40 and inbox button 42. Alternatively, patient medical record system 20 may provide audio communication, or combinations of screen-based and audio communication.

Login screens 22 query a physician or user for security information to guarantee that authorization and access to the system is properly granted. For example, a neurosurgeon provides a specific password or other security information for proper access verification. Patient record system 20 then presents inbox screen 24 from which the user controls medical information retrieval, input and display. Medical navigation template 40 is displayed concurrently with inbox screen 24 and provides interactive capabilities such that the user can control and select changed to a variety of other screen views.

Any of screens 24, 26, 28, 30 and 32 may include interactive attributes and provide access to individual chart screens 44. From individual chart screens 44, communication with data 46 may be established. Individual chart screens 44 display patient information and related medical data for a unique patient. Data 40 is medical information related to the patient and may further include links to other data sources, audio data and video data.

FIG. 2 shows an exemplary graphical user interface screen generally depicted at 200.

Interactive GUI screen 200 may be used for chart locator screens, planner screens, communication screens, reference screens, and individual chart screens. Graphical user interface screen 200 includes interactive graphics ergonomically selected, shaped and arranged based on physician workflow related to patient medical analysis, such as but not limited to, medical navigation template 220, inbox navigation template 230, control template 240, data acquisition template 250, and patient identification icon 270. The interactive attributes associated with the graphics may be touchscreen activated via a human hand or other activation instrument. Alternatively, voice activation may be utilized.

Universal to each type of screen provided as interactive GUI screen 200 are medical navigation template 220, inbox navigation template 230, control template 240 and data acquisition template 250. These templates allow user manipulation, including storing and retrieval of information, and relate functionally to data acquisition and analysis.

Although universally displayed with each type of screen provided, the templates are differentiable based on functionality. Medical navigation template 220 and inbox navigation template 230 are associated with functionality related to navigation within the patient medical record system. For example, when activated, medical navigation template 220 and inbox navigation template 230 retrieve and display different screens. Whereas, control template 240 and data acquisition template 250 are associated with functionality related to navigation action within and based on the display of the current view area 275. For example, data acquisition template 250 performs action such as linking to additional information related to or referenced regarding particular or generally all information displayed on view area 275, and control template 240 navigates (up, down, left, right, etc.) within view area 275.

Medical navigation template 220 is displayed as an interactive graphic which includes buttons 260 related to a planner, charts, communication, and reference library and is universally present on substantially all screens. Buttons 260 alternate between an “active” status or an “inactive” status. A user may select and activate, one at a time, particular buttons 260 and thereby retrieve a specific screen related to activated button 260. In the preferred embodiment, Reference Library button 260a is active, and therefore graphically modified compared to other inactive buttons. The retrieval of the specific screen replaces the current view of the user screen 200 with the specific screen. For example, a user who activates the chart button 260b retrieves a chart screen that is displayed on graphical user interface screen 200, from which the user may continue manipulating information and performing the patient medical analysis.

Inbox navigation template 230 is displayed preferably as an individual interactive graphic and is universally present on substantially all screens. Inbox navigation template 230 provides similar functionality as buttons 260 of medical navigation template 220. Inbox navigation template 230 alternates between active or inactive. Inbox navigation template 230 may be activated to retrieve the inbox screen that replaces the current view of user screen 200. For example, a user who activates inbox navigation template 230 retrieves their particular inbox screen that is then displayed on user screen 200.

Control template 240 includes a number of interactive global function buttons that control the display of the user screen 200 relative to previous retrievals and future retrievals, and allow navigation within the information displayed on user screen 200. For illustration purposes, control template 230 includes buttons 280a-d such as back 280a, forward 280b and select 280c which retrieve other screens besides the one currently displayed, additionally backward/forward buttons 280d allow cursor movement within view area 275 currently displayed such that the user may navigate the visual information within a screen.

In the preferred embodiment, control template 240 further includes global function communication buttons such as bookmark button 285 and dictate button 290. Bookmark button 285 allows a user to input or access visually reference mark information displayed on the particular screen or within view area 275 as textual or graphic information. Dictate button 290 allows a user to input or access audibly reference mark information communicated with relation to the particular screen or view area 275. Dictate button 290 therefore integrates traditional dictation of physician work flow into the system. The global function communication buttons allow users real time storage of their analysis for greater accuracy and availability. In this manner, attending physicians may archive and retrieve pertinent medical data and analysis information, and thus are greatly assisted by patient medical system as a medical diagnostic tool while utilizing preexisting habits of their established work flow.

Data acquisition template 250 includes interactive data buttons 255A-F that are linked or referenced to medical related data sources. Non-limiting examples of data sources include history and examinations 255A, allergies and substance abuse/habits 255B, testing and imaging 255C, consultations/reports 255D, and demographics/insurance 255E. Data sources may be located locally or remotely (and retrievable via the network). For each patient medical analysis, the data sources may be queried for relevant information that assists the physician's professional determination.

FIG. 3 illustrates a bookmark screen 300 retrievable via a link activated by the bookmark button on another screen. Bookmark screen 300 displays universal medical navigation template 220, inbox navigation template 230 and control template 240, which are supplied with substantially each screen displayed. An input screen 310, an add bookmark button 320, a delete bookmark button 330 are displayed on bookmark user screen 300. Add bookmark button 320 provides a “bookmark” or reference indication for the particular screen in which bookmark button was activated. For example, a user viewing a particular chart screen may want to reference or “bookmark” the chart for easy retrieval in the future, and therefore activates the bookmark button at that chart screen. Bookmark screen 300 replaces the view of the current chart screen. Now, the physician uses add bookmark button 320 and implements such a reference. Delete bookmark button 330 removes such a “bookmark.”

FIG. 4 illustrates a dictation screen 400 retrievable via a link activated by the dictation button on another screen. Dictation screen 400 displays universal medical navigation template 220, inbox navigation template 230, and control template 240 which are supplied with substantially every screen displayed. Functional dictation buttons 410A-E, including record 410A, stop 410B, play 410C and pause 410D, and submit 410E, which saves the dictation, are disposed in dictation screen 420 and are interactive. In the preferred embodiment, dictation screen 420 displays visual information related to the dictation. For illustration purposes, dictation screen 470 includes cursor buttons 430 which navigate through the visual information displayed on dictation screen 400, and dictation buttons 440.

FIG. 5 illustrates a research screen 500 retrievable by a link activated via the reference button. Additionally, search buttons 510a-f and input device 520 are displayed in dictation screen 530. In the preferred embodiment, dictation screen 530 displays visual information related to the searching. For illustration purposes, search buttons 510 allow a user to navigate to create a new search or search reference sources such as textbooks, journals and customized sources. Input device 520 allows a user to enter textual data. In the preferred embodiment, input device 520 is a keyboard. Alternatively, the input device may be a dictation device for entering audio information, an electronic scanner for entering visual information.

FIG. 6 illustrates inbox screen 600 that is preferably retrievable by a link activated via the inbox button on another screen. Inbox screen 600 displays the universal medical navigation template 220, inbox navigation template 230, control template 240 and data acquisition template 250 which are supplied with substantially every screen displayed. In the preferred embodiment, data acquisition template 250 includes buttons 620 that index particular new information. Buttons 620 alternate between active and inactive. An active button 620 changes graphically. For illustration purposes, “new tests” button 620a is activated, and therefore graphically modified compared to all other inactive buttons. For illustration purposes, data acquisition template buttons include alerts 620a, new test results 620b, and correspondences 620c. Each of the buttons, when activated, link to and display an interactive item list 630 showing the related new information as test result item 660. Test result items 660 are selectable. For illustration purposes, a selected test result item 660a graphically changes to show a highlighted background. One test result item 660 may be selected at a time. If one of four test result items 660 is selected, related patient information is also displayed at picture icon 640 and patient identification display 650. Picture icon 640 and patient identification display 650 correspond to and change according to the selected test result item 660a. For example, patient identification display includes information such as name, age, date of birth. If “new tests” button 620a is activated, inbox screen 600 displays interactive item list 630 including selected test result item 660a “MRI test result.” The physician may now further activate selected test result item 660 that may be linked to additional medical information such as the MRI image.

FIG. 7 illustrates an example of one chart view screen of a hypothetical patient's medical record.

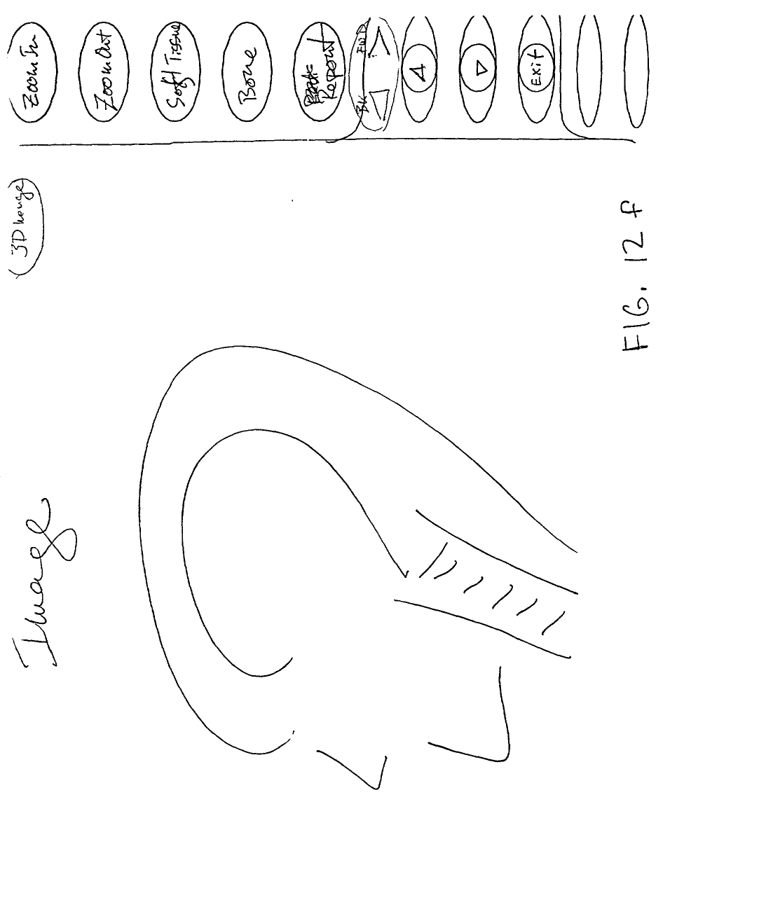

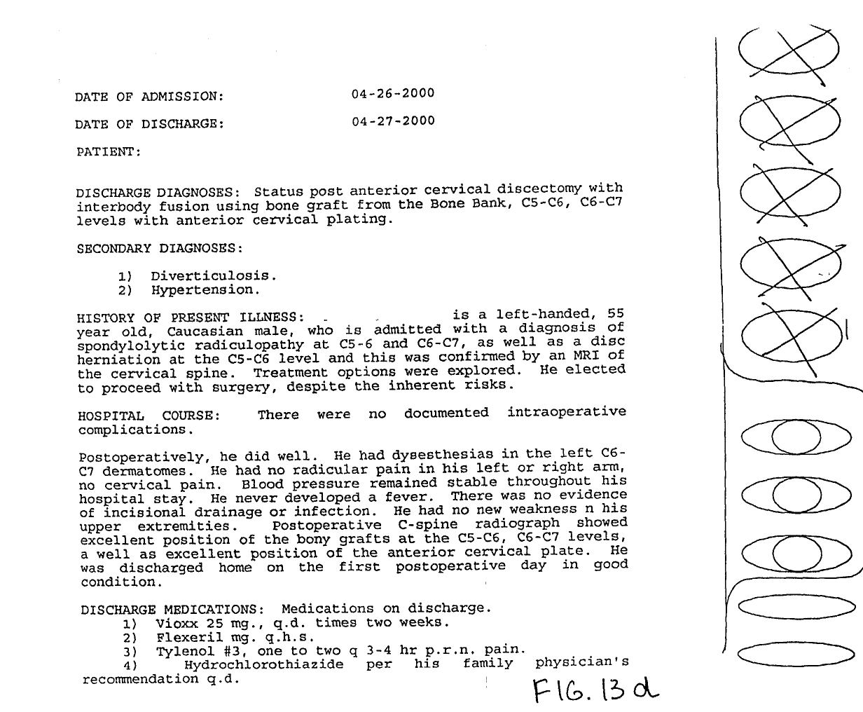

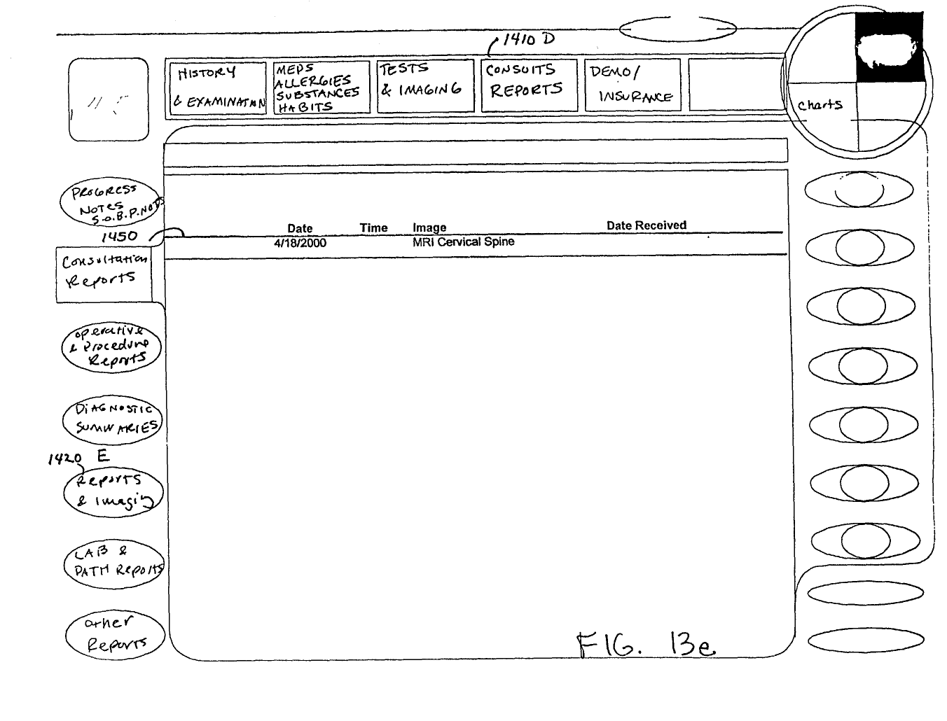

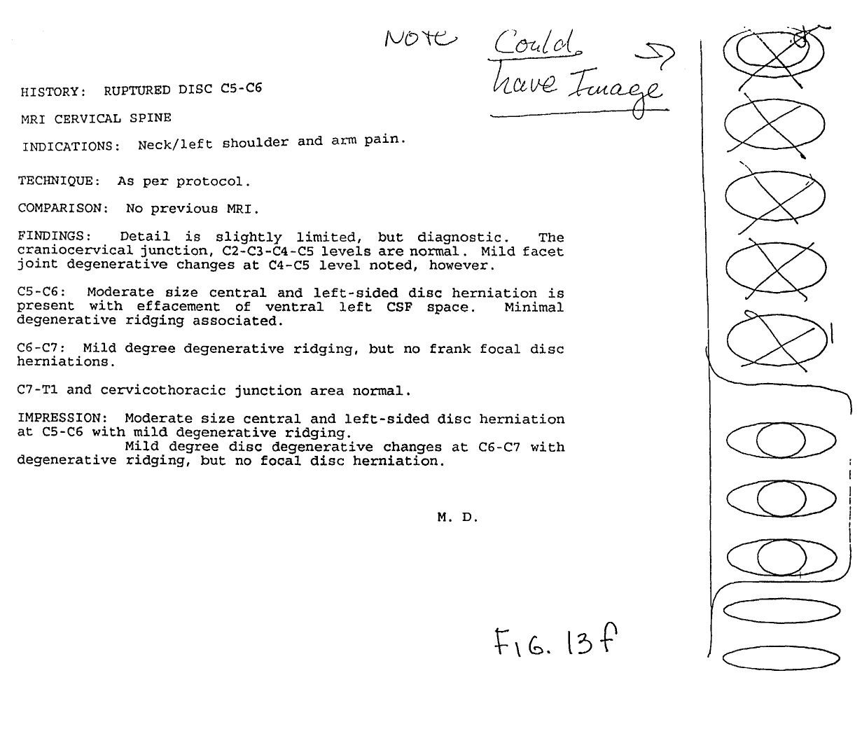

A site map is generally depicted at 800 of FIG. 8. The site map illustrates the relationship of the various buttons and associated links (to other buttons or screens) employed in the preferred embodiment. A user enters and retrieves patient data or medical information using navigation buttons. A selected navigation button implements linking to certain information or data. A certain combination of buttons may be selected to navigate to a particular screen and further launch other screens, query for additional patient data or medical information, or input additional patient data or medical information. For example, combinations of the navigation buttons yield retrieval of information associated with data acquisition templates (history and navigation, allergies and substance abuse/habits, testing and imaging, consultations/reports and demographics and insurance.) For further explanation regarding the acquisition of information from the data acquisition templates, Table 1 is provided below. The table references FIGS. 10-13 and shows which screen displays are active when selected top buttons and side buttons are chosen.

TABLE 1

| Data | | | | | |
|---|---|---|---|---|---|
| Acquisition | | Top | Side | Other | |
| Template | FIGURE | Button | Button | Button (s) | Screen Display |
| History and | 10a | 1110A | 1120B | 1160 | |
| Examination | | | | | |
| | 10a | 1110A | 1120B | 1150 | |
| | 10a | 1110A | 1120B | | |
| | 10a | 1110A | 1120B | 1130 | |
| | 10a | 1110A | 1120B | 1140 | |
| | 10e | 1110C | 1120B | 1162 | |
| | 10e | 1110C | 1120B | 1170 | |
| | 10h | 1110A | 1120C | | |
| | 10i | 1110A | 1120C | | |
| | 10b | 1110A | 1120E | | |
| Medical | 11a | 1210B | 1220A | | |
| Allergies | | | | | |
| Substance | | | | | |
| Abuse and | | | | | |
| Habits | | | | | |
| | 11a | 1210B | 1220B | | |
| | 11b | 1210B | 1220A | | |
| Tests and | 12a | 1310C | 1320 | | |
| Imaging | | | D/E/F | | |
| | 12a | 1310C | 1320D | 1330 | |
| | 12c | 1310C | 1320A | | |
| | 12c | 1310C | 1320A | 1340 | |
| | 12e | 1310C | 1320B | | |
| Consults and | 13a | 1410D | 1420C | | |
| Reports | | | | | |
| | 13a | 1410D | 1420B | 1430 | |
| | 13c | 1410D | 1420D | | |
| | 13c | 1410D | 1420D | 1440 | |
| | 13e | 1410D | 1420E | | |
| | 13e | 1410D | 1420E | 1450 | FIG. 13f |

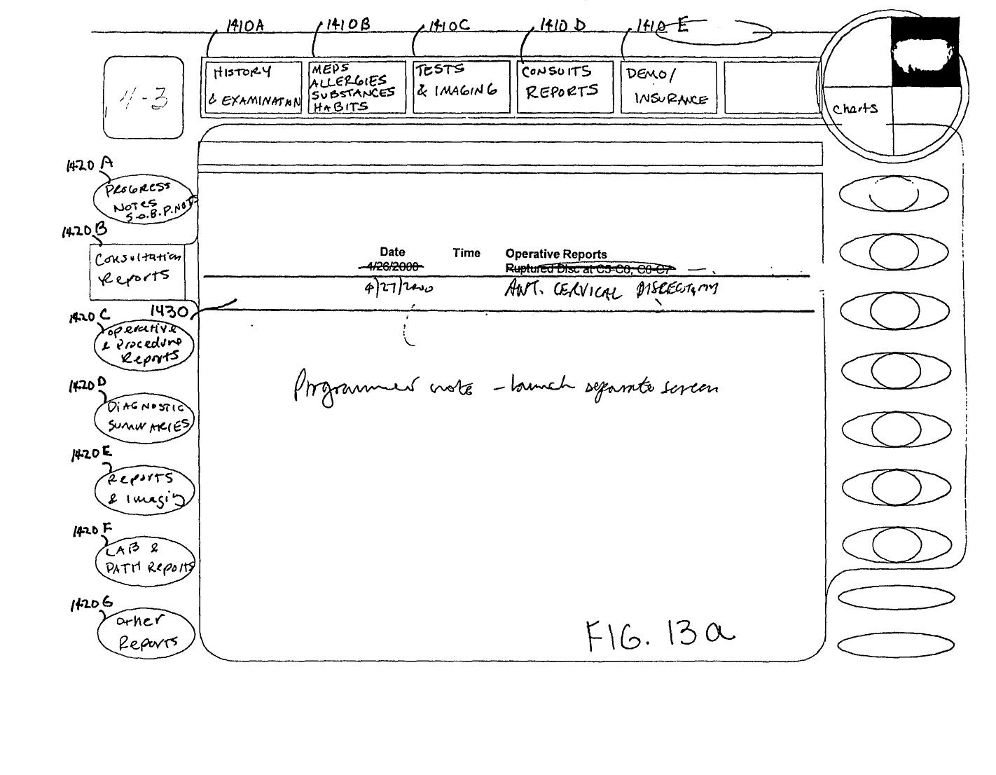

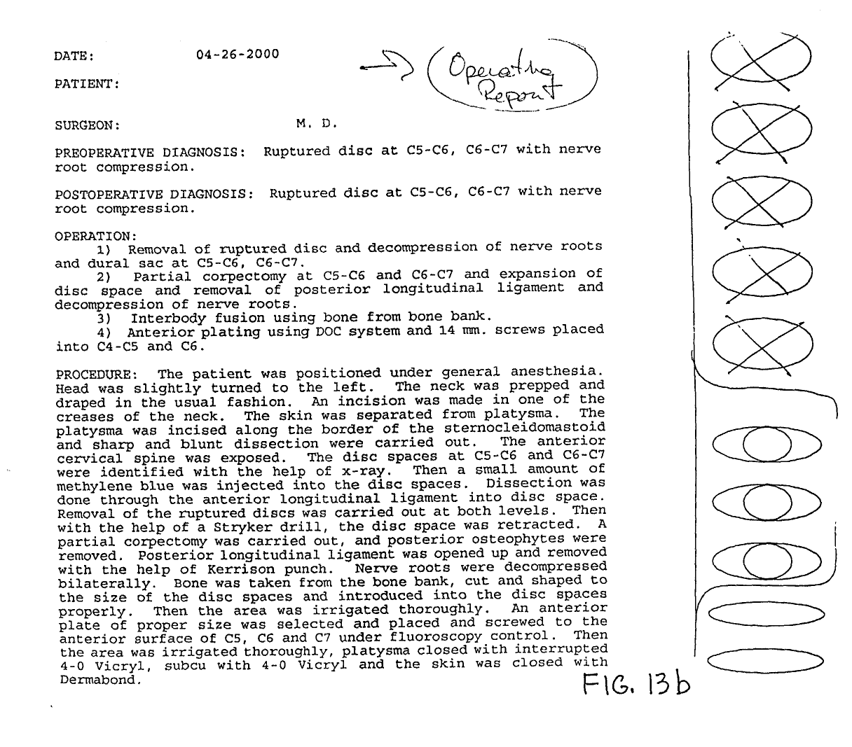

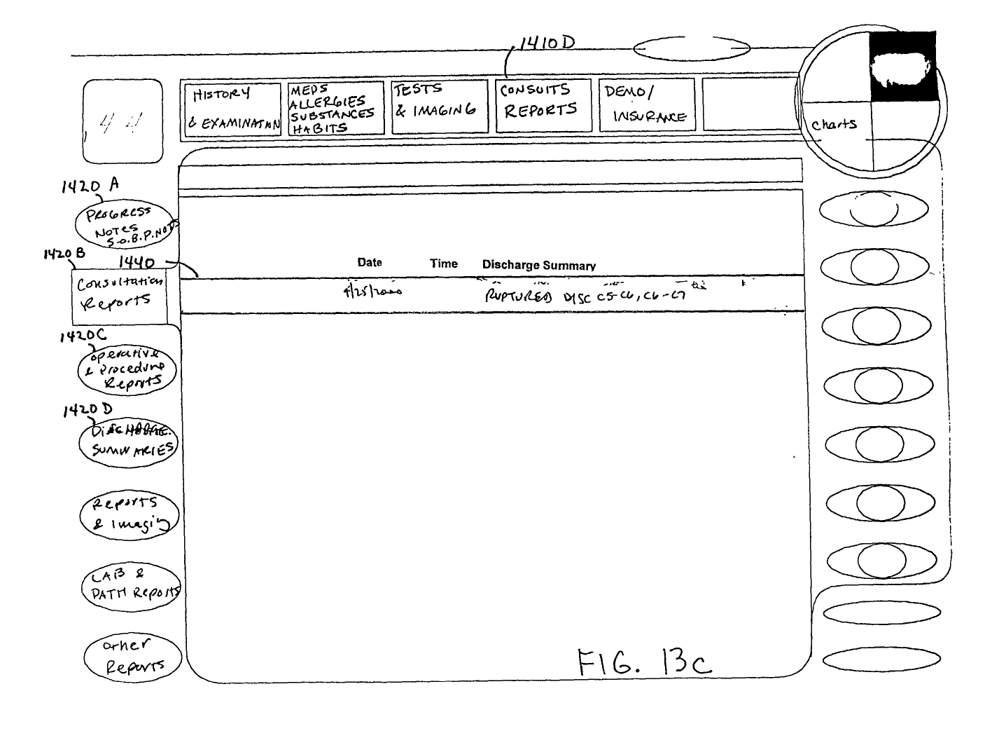

FIG. 9 provides a detailed block diagram of the patient record system of the present invention. Patient record system 900 includes GUI 920, application 930, data access 940 and data layer 950. GUI 920 is preferably interactive and implemented by a touch-screen or other similar interactive input technology which allows a user to easily enter, obtain and manipulate data within patient record system 900.

Application 930 includes expert system plug-in 960 that is based on the particular user (or medical professional) such as a neurosurgeon, internal medicine specialist, or psychiatrist. Expert plug-in system 960 may be implemented in software. In the preferred embodiment, plug-in 960, based on the particular user, configures GUI 920, selects display screens and layouts, provides navigation buttons with related functions, such as linking, which retrieves certain display screens. Thus, a configured user environment is established which is customized to the particular needs of a user. This makes the patient record system easy for use, quickly accessible for a high speed work flow environment, functional for specialized medical analysis and dependable for retrieval of desired information. During the use of patient record system, application 930 transmits data input, retrieval and manipulation.

Data input, retrieval and manipulation require transmission and communication between application 930 and data layer 950. Data layer 950 may include multiple data formats from a variety of sources. The various formats include native formats 960, foreign formats 970 and portable formats 980 (such as compact discs). Accordingly, data access 940 includes translation of various data formats thus facilitating transmission of data between application 930 and data layer 950.

While the invention has been described in its presently preferred embodiment, it will be understood that the invention is capable of modification without departing from the spirit and cope of the invention as set forth in the appended claims.

What is claimed is:

1. A medical information management system, comprising:
a networked connection to at least one source of medical record information;
a main display window;
a first set of navigation buttons associated with said main display window;
a second set of navigation buttons associated with said main display window and linked to said first set of navigation buttons;
said first and second set of navigation buttons being operative to access said medical records via said networked connection and to selectively display information based on said medical records in said main display window.

2. The system of claim 1 wherein said networked connection is a wireless connection.

3. The system of claim 1 further comprising handheld display device having touch screen interface and wherein said main display window and said first and second set of navigation buttons are implemented using said display device.

4. The system of claim 1 further comprising expert system plugin module for controlling the manner in which said first and second set of navigation buttons interact to selectively display information in said main display window.

5. The system of claim 1 further comprising networked connection to at least one electronic mail server system and wherein selected ones of said first and second set of navigation buttons interface with said mail server system to integrate electronic mail messages with said medical record information.

6. The system of claim 1 further including bookmark system that integrates with said navigation buttons and said main display window, said bookmark system having local data storage for preserving a record of user-selected information for later display within said main display window.

7. The system of claim 1 wherein selected ones of said first and second set of navigation buttons have associated record filtering functionality capable of restricting the content displayed in said main display window.

8. The system of claim 1 wherein said main display window supports the display of multimedia information.

9. The system of claim 1 further including voice dictation interface through which the user enters voice dictation for storage and subsequent retrieval.

10. The system of claim 9 wherein said voice dictation interface is a wireless interface communicating with said information management system in response to selected ones of said navigation buttons.
